(19) United States
(12) Patent Application Publication
(10) Pub. No.: US 2013/0185378 A1
(43) Pub. Date: Jul. 18, 2013

(54) CACHED HASH TABLE FOR NETWORKING

(71) Applicant: LineRate Systems, Inc., Louisville, CO (US)

(72) Inventors: John Giacomoni, Longmont, CO (US); Manish Vachharajani, Lafayette, CO (US)

(73) Assignee: LineRate Systems, Inc., Louisville, CO (US)

(21) Appl. No.: 13/744,677

(22) Filed: Jan. 18, 2013

Related U.S. Application Data
(60) Provisional application No. 61/587,886, filed on Jan. 18, 2012.

(51) Int. Cl. G06F 15/167

(52) U.S. Cl. CPC G06F 15/167
USPC 709/213

(57) ABSTRACT

Systems, methods, and devices are provided for managing hash table lookups. In certain network devices, a hash table having multiple buckets may be allocated for network socket lookups. Network socket information for multiple open network socket connections may be distributed among the buckets of the hash table. For each of the buckets of the hash table, at least a subset of the network socket information that is most likely to be used may be identified, and the identified subset of most likely to be used network socket information may be promoted at each bucket to a position having a faster lookup time than a remaining subset of the network socket information at that bucket.

### CROSS-REFERENCE

The present application claims priority under 35 U.S.C. § 119 to U.S. Provisional Patent Application Ser. No. 61/587,886, entitled “CACHED HASH TABLE FOR NETWORKING,” which was filed on Jan. 18, 2012, the entirety of which is incorporated by reference herein for all purposes.

### BACKGROUND

Aspects of the invention relate to computer networks, and more particularly, providing dynamically configurable high-speed network services for a network of computing devices.

Organizations often use multiple computing devices. These computing devices may communicate with each other over a network, such as a local area network or the Internet. In such networks, it may be desirable to provide various types of network services. Examples of such network services include, among others, firewalls, load balancers, storage accelerators, and encryption services. These services may help ensure the integrity of data provided over the network, optimize connection speeds and resource utilization, and generally make the network more reliable and secure. For example, a firewall typically creates a logical barrier to prevent unauthorized traffic from entering or leaving the network, and an encryption service may protect private data from unauthorized recipients. A load balancer may distribute a workload across multiple redundant computers in the network, and a storage accelerator may increase the efficiency of data retrieval and storage.

These network services can be complicated to implement, particularly in networks that handle a large amount of network traffic. Often such networks rely on special-purpose hardware appliances to provide network services. However, special-purpose hardware appliances can be costly and difficult to maintain. Moreover, special-purpose hardware appliances may be inflexible with regard to the typical ebb and flow of demand for specific network services. Thus, there may be a need in the art for novel system architectures to address one or more of these issues.

### SUMMARY

Methods, systems, and devices are described for managing network socket information in hash tables.

In a first set of embodiments, a method of managing network socket lookups may include allocating a hash table for network socket lookups in a network device, the hash table comprising a plurality of buckets; distributing network socket information for a plurality of open network socket connections among the buckets of the hash table;

identifying, for each of the buckets of the hash table, at least a subset of the network socket information associated with that bucket that is most likely to be used; and promoting the identified subset of most likely to be used network socket information at each bucket to a position comprising a faster lookup time than a remaining subset of network socket information associated with that bucket.

In a second set of embodiments, a network device for managing network socket information may include a memory configured to store a hash table allocated to network socket lookups, the hash table comprising a plurality of buckets; and at least one processor communicatively coupled with the memory. The processor may be configured to: distribute network socket information for a plurality of open network socket connections among the buckets of the hash table; identify, for each of the buckets of the hash table, at least a subset of the network socket information associated with that bucket that is most likely to be used; and promote the identified subset of most likely to be used network socket information at each bucket to a position comprising a faster lookup time than a remaining subset of network socket information associated with that bucket.

In a third set of embodiments, a computer program product for managing network socket information may include a tangible computer readable storage device having a plurality of computer readable instructions stored thereon. The computer-readable instructions may include computer-readable instructions configured to cause at least one processor to allocate a hash table for network socket lookups in a network device, the hash table comprising a plurality of buckets; computer-readable instructions configured to cause at least one processor to distribute network socket information for a plurality of open network socket connections among the buckets of the hash table; computer-readable instructions configured to cause at least one processor to identify, for each of the buckets of the hash table, at least a subset of the network socket information associated with that bucket that is most likely to be used; and computer-readable instructions configured to cause at least one processor to promote the identified subset of most likely to be used network socket information at each bucket to a position comprising a faster lookup time at that bucket than a remaining subset of network socket information associated with that bucket.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a system including components configured according to various embodiments of the invention;

FIG. 2A and FIG. 2B are block diagrams of examples of a self-contained network services system configured according to various embodiments of the invention;

FIG. 3A and FIG. 3B are block diagrams of examples of a network services module including components configured according to various embodiments of the invention;

FIG. 4 is a block diagram of a network services operating system architecture according to various embodiments of the invention;

FIG. 5 is a block diagram of a balanced network stack access scheme in a network services operating system according to various embodiments of the invention;

FIG. 6A is a block diagram of a balanced thread distribution scheme in a network services operating system according to various embodiments of the invention;

FIG. 6B is a block diagram of a balanced thread distribution scheme in a network services operating system according to various embodiments of the invention;

FIG. 7 is a block diagram of an example of a server including components configured according to various embodiments of the invention;

FIG. 8 is a diagram of an example of a hash table in a network services operating system according to various embodiments of the invention;

FIG. 9 is a flowchart diagram of an example of a hash table in a network services operating system according to various embodiments of the invention;

FIG. 10 is a flowchart diagram of an example of a method of managing hash table lookup operations in an operating system according to various embodiments of the invention;

FIG. 11 is a flowchart diagram of an example of a method of managing hash table lookup operations in an operating system according to various embodiments of the invention;

FIG. 12 is a flowchart diagram of an example of a method of managing hash table lookup operations in an operating system according to various embodiments of the invention;

FIG. 13A is a flowchart diagram of an example of a method of managing hash table lookup operations in an operating system according to various embodiments of the invention;

FIG. 13B is a flowchart diagram of an example of a method of managing hash table lookup operations in an operating system according to various embodiments of the invention;

FIG. 13C is a flowchart diagram of an example of a method of managing hash table lookup operations in an operating system according to various embodiments of the invention; and

FIG. 14 is a schematic diagram that illustrates a representative device structure that may be used in various embodiments of the present invention.

### DETAILED DESCRIPTION OF THE INVENTION

Systems, methods, and devices are provided for managing hash table lookups. In certain hash tables, one or more buckets may be associated with a container containing a collection of records containing data. A number of most likely to be used (e.g., based on recency of use, frequency of use, or combinations thereof) records in the container may be identified, and these records may be positioned in the container (e.g. at the head of a linked list) such that the lookup efficiency for the most likely to be used records is greater than that of the remaining records in the container. In certain hash tables, each bucket may include a cache for storing information about a number of identified records in the container associated with the bucket. The cache may store information about the most recently or frequently used nodes in the container, and may include pointers to those nodes in the container. Because cache lookup operations are typically faster than performing lookup operations in a container, lookup operations for the most active nodes in the container may be faster, leading to an overall improvement in hash table efficiency.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used in the present specification and in the appended claims, the term “network socket” or “socket” refers to an endpoint of an inter-process communication flow across a computer network. Network sockets may rely on a transport-layer protocol (e.g., Transmission Control Protocol (TCP), User Datagram Protocol (UDP), etc.) to transport packets of a network layer protocol (e.g., Internet Protocol (IP), etc.) between two applications.

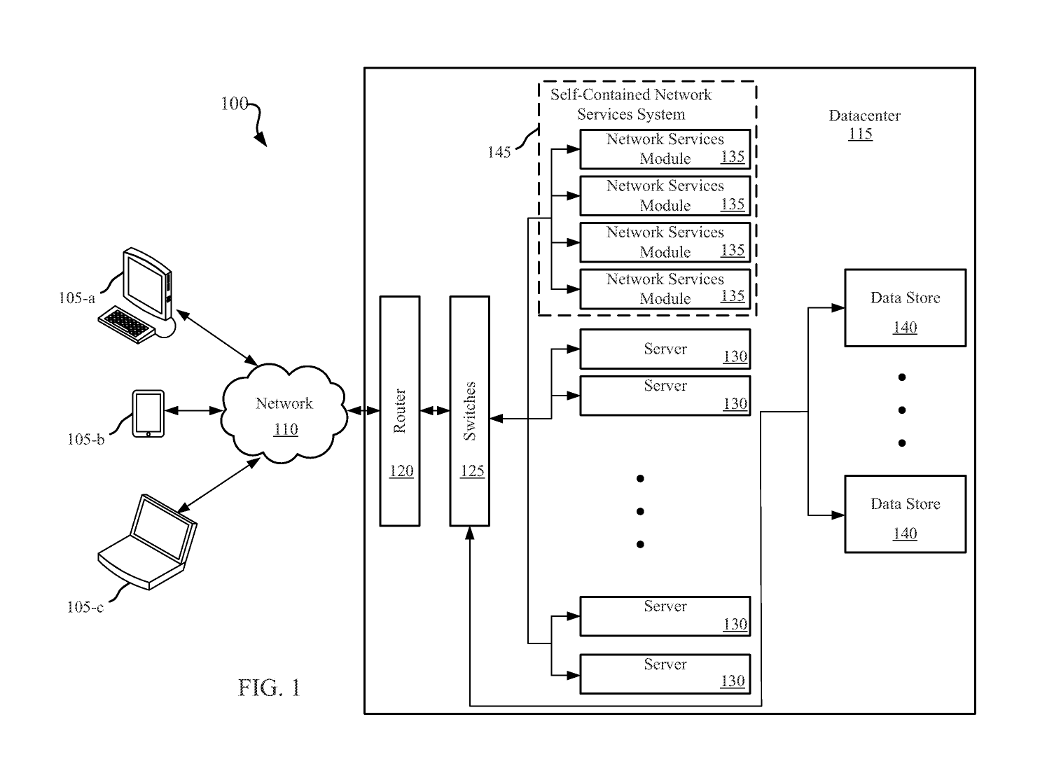

Systems, devices, methods, and software are described for providing dynamically configurable network services at high-speeds using commodity hardware. In one set of embodiments, shown in FIG. 1, a system 100 includes client devices 105 (e.g., desktop computer 105-a, mobile device 105-b, portable computer 105-c, or other computing devices), a network 110, and a datacenter 115. Each of these components may be in communication with each other, directly or indirectly.

The datacenter 115 may include a router 120, one or more switches 125, a number of servers 130, and a number of data stores 140. For the purposes of the present disclosure, the term “server” may be used to refer to hardware servers and virtual servers. Additionally, the term “switch” may be used to refer to hardware switches, virtual switches implemented by software, and virtual switches implemented at the network interface level. In certain examples, the data stores 140 may include arrays of machine-readable physical data storage. For example, data stores 140 may include one or more arrays of magnetic or solid-state hard drives, such as one or more Redundant Array of Independent Disk (RAID) arrays.

The datacenter 115 may be configured to receive and respond to requests from the client devices 105 over the network 110. The network 110 may include a Wide Area Network (WAN), such as the Internet, a Local Area Network (LAN), or any combination of WANs and LANs. Each request from a client device 105 for data from the datacenter 115 may be transmitted as one or more packets directed to a network address (e.g., an Internet Protocol (IP) address) associated with the datacenter 115. Using the network address, the request may be routed over the network 110 to the datacenter 115, where the request may be received by router 120.

Each request received by router 120 may be directed over the switches 125 to one of the servers 130 in the server bank for processing. Processing the request may include interpreting and servicing the request. For example, if the request from the client device 105 is for certain data stored in the data stores 140, interpreting the request may include one of the servers 130 identifying the data requested by the client device 105, and servicing the request may include the server 130 formulating an instruction for retrieving the requested data from the data stores 140.

This instruction may be directed over one or more of the switches 125 to a data store 140, which may retrieve the requested data. In certain examples, the request may be routed to a specific data store 140 based on the data requested. Additionally or alternatively, the data stores 140 may store data redundantly, and the request may be routed to a specific data store 140 based on a load balancing or other functionality.

Once the data store 140 retrieves the requested data, the switches 125 may direct the requested data retrieved by the data store 140 back to one of the servers 130, which may assemble the requested data into one or more packets addressed to the requesting client device 105. The packet(s) may then be directed over the first set of switches 125 to router 120, which transmits the packet(s) to the requesting client device 105 over the network 110.

In certain examples, the datacenter 115 may implement the back end of a web site. In these examples, the data stores 140 may store Hypertext Transfer Markup Language (HTML) documents related to various component web pages of the web site, in addition to data (e.g., images, metadata, media files, style sheets, plug-in data, and the like) embedded in or otherwise associated with the web pages. When a user of one of the client devices 105 attempts to visit a web page of the website, the client device 105 may contact a Domain Name Server (DNS) to look up the IP address associated with a domain name of the website. The IP address may be the IP address of the datacenter 115. The client device 105 may then transmit a request for the web page to the datacenter 115 and receive the web page in the aforementioned manner.

Datacenters 115 and other network systems may be equipped to handle large quantities of network traffic. To effectively service this traffic, it may be desirable to provide certain network services, such as firewall services, security services, load balancing services, and storage accelerator services. Firewall services provide logical barriers to certain types of unauthorized network traffic according to a set of rules. Security services may implement encryption, decryption, signature, and/or certificate functions to prevent unauthorized entities from viewing network traffic. Load balancing services may distribute incoming network traffic among the servers 130 to maximize the productivity and efficiency. Storage accelerator services distribute requests for data among data stores 140 and cache recently or frequently requested data for prompt retrieval.

In some datacenters, these network services may be provided using special purpose hardware appliances. For example, in some datacenters similar in scope to datacenter 115, a special-purpose firewall appliance and a special-purpose security appliance may be placed in-line between the router and the first set of switches. Additionally, a special-purpose load balancing appliance may be placed between the first set of switches and the servers, and a special-purpose storage accelerator appliance may be placed between the second set of switches and the data stores.

However, the use of special-purpose hardware appliances for network services may be undesirable for a number of reasons. Some special-purpose hardware appliances may be expensive, and can costing orders of magnitude more than commodity servers. Special purpose hardware appliances may also be difficult to manage, and may be unable to dynamically adapt to changing network environments. Moreover, special-purpose hardware appliances often may be unable to leverage the continuously emerging optimizations for commodity server architectures.

The datacenter 115 of FIG. 1 may avoid one or more of the aforementioned disadvantages associated with special-purpose hardware appliances through the use of a block of commodity or general-purpose servers 130 that can be programmed to act as dynamically configurable network services modules 135. The network services modules 135 collectively function as a self-contained network services system 145 by executing special-purpose software installed on the servers 130 in the dedicated block. For purposes of the present disclosure, the term “self-contained” refers to the autonomy of the network services system 145 implemented by the network services modules 135. Each of the network services modules 135 in the self-contained network services system 145 may be programmed with special-purpose network services code which, when executed by the network services modules 135, causes the network services modules 135 to implement network services . It should be understood that the servers 130 implementing the network services modules 135 in the self-contained network services system 145 are not limited to network services functionality. Rather, the servers 130 implementing the network services modules 135 in the network services system 145 may also execute other applications that are not directly related to the self-contained network services system 145.

Use of commodity servers 130 in the datacenter 115 may allow for elastic scalability of network services. Network services may be dynamically added, removed, or modified in the datacenter 115 by reprogramming one or more of the network services modules 135 in the self-contained network services system 145 with different configurations of special-purpose code according to the changing needs of the datacenter 115.

Furthermore, because the network services are provided by programming commodity servers with special-purpose code, some of the servers 130 in the server bank of the datacenter 115 may be allocated to the self-contained network services system 145 and configured to function as virtual network services modules 135. Thus, in certain examples, the number of servers 130 allocated to the self-contained network services system 145 may grow as the datacenter 115 experiences increased demand for network services. Conversely, as demand for network services wanes, the number of servers 130 allocated to the self-contained network services system 145 may shrink to more efficiently use the processing resources of the datacenter 115.

The self-contained network services system 145 may be dynamically configurable. In some embodiments, the type and scope of network services provided by the network services system 145 may be modified on-demand by a datacenter administrator or other authorized individual. This reconfiguration may be accomplished by interacting with a network services controller application using a Graphical User Interface (GUI) or Command Line Interface (CLI) over the network (110) or by logging into one of the network services modules 135 locally.

The configuration of the network services system 145 may be quite adaptable. As described above, network services applications may be dynamically loaded and removed from individual network services modules 135 to add or remove different types of network services functionality. Beyond the selection of which network services applications to execute, other aspects of the network services system 145 operations may be customized to suit a particular set of network services needs.

One such customizable aspect is the computing environment (e.g., dedicated hardware, virtual machine within a hypervisor, virtual machine within an operating system) in which a particular network services application is executed. Other customizable aspects of the network services system 145 may include the number of network services applications executed by each instance of an operating system, the number of virtual machines (if any) implemented by the network services modules 135, the total number of instances of each network services application to be executed concurrently, and the like. In certain examples, one or more of these aspects may be statically defined for the network services system 145. Additionally or alternatively, one or more of these aspects may be dynamically adjusted (e.g., using a rules engine and/or in response to dynamic input from an administrator) in real-time to adapt to changing demand for network services.

Each of the servers 130 implementing a network services module 135 may function as a virtual network appliance in the self-contained network services system 145 and interact with other components of the datacenter 115 over the one or more switches 125. For example, one or more network services modules 135 may function as a firewall by receiving all packets arriving at the router 120 over the one or more switches 125, applying one or more packet filtering rules to the incoming packets, and directing approved packets to a handling server 130 over the one or more switches 125. Similarly, one or more network services modules 135 may function as a storage accelerator by receiving data storage commands over the one or more switches 125.

Thus, because the network services can be performed directly from the server bank through the use of switches 125 there is no need to physically reconfigure the datacenter 115 when network services are added, modified, or removed.

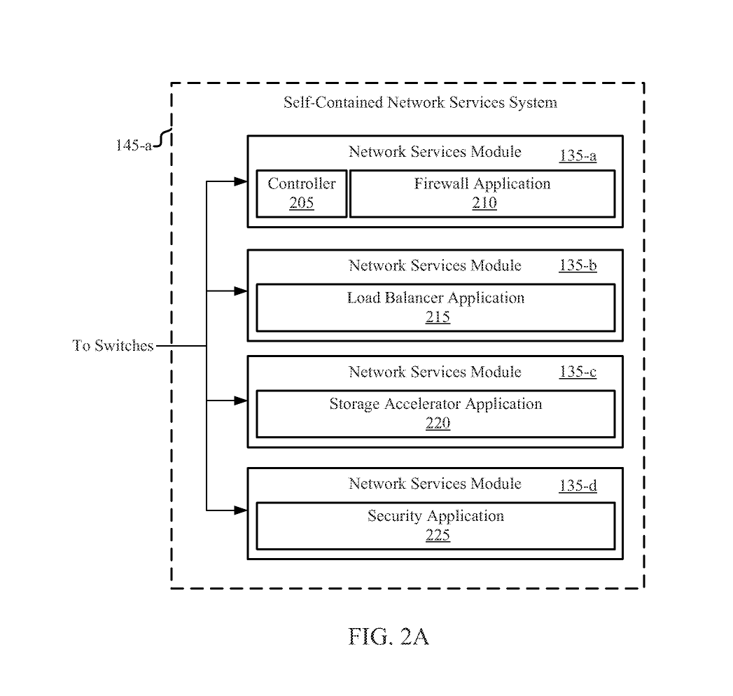

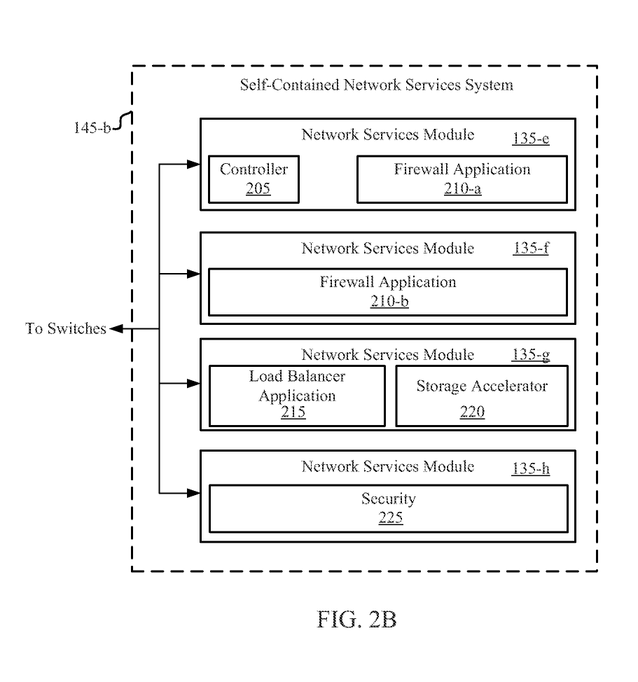

FIGS. 2A and 2B show two separate examples of configurations of network services modules 135 as network services appliances in self-contained network services systems 145 (e.g., the self-contained network services system 145 of FIG. 1).

FIG. 2A shows a self-contained network services system 145-a that includes four commodity servers which are specially programmed to function as network services modules 135. The self-contained network services system 145-a and network services modules 135 may be examples of the self-contained network services system 145 and network services modules 135 described above with reference to FIG. 1.

The network services implemented by each network services module 135 are determined by special-purpose applications executed by the network services modules 135. In the present example, network services module 135-a has been programmed to execute a firewall application 210 to implement a firewall appliance. Network services module 135-b has been programmed to execute a load balancing application 215 to implement a load balancer appliance. Network services module 135-c has been programmed to execute a storage accelerator application 220 to implement a storage accelerator appliance. Network services module 135-d has been programmed to execute a security application 225 to implement a security appliance. It should be recognized that in certain examples, multiple instances of the same network services application may be executed by the same or different network services modules 135 to increase efficiency, capacity, and service resilience.

Additionally, network services module 135-a executes a network services controller application 205. The network services controller application 205 may, for example, coordinate the execution of the network services applications by the network services modules 135. For example, the network services controller application 205 may communicate with an outside administrator to determine a set of network services to be implemented and allocate network services module 135 resources to the various network services applications to provide the specified set of network services. In certain examples, the functionality of the network services controller application 205 may be distributed among multiple network services modules 135. In other examples, at least one of the network services applications 205, 210, 215, 220, 225 may be performed by special-purpose hardware or by a combination of one or more network services modules 135 and special-purpose hardware. Thus, the self-contained network services system 145-b may supplement or replace special-purpose hardware in performing network services.

FIG. 2B shows an alternate configuration of network services modules 135-e to 135-h in a self-contained network services system 145-b of a datacenter (e.g., datacenter 115 of FIG. 1). The self-contained network services system 145-b and network services modules 135-a to 135-d may be examples of the self-contained network services system 145-a and network services modules 135 described above with reference to FIG. 1 or 2A. In contrast to the configuration of FIG. 2A, the configuration of FIG. 2B allocates two network services modules 135-e, 135-f to executing firewall applications 210 for the provision of firewall services. Additionally, the present example divides the resources of network services module 135-g between the load balancing application and the storage acceleration application. In one example, the configuration of the network services modules 135 in a self-contained network services system 145 may be switched from that shown in FIG. 2A to that shown in FIG. 2B in response to an increased demand for firewall services and a decreased demand for load balancing and storage acceleration services.

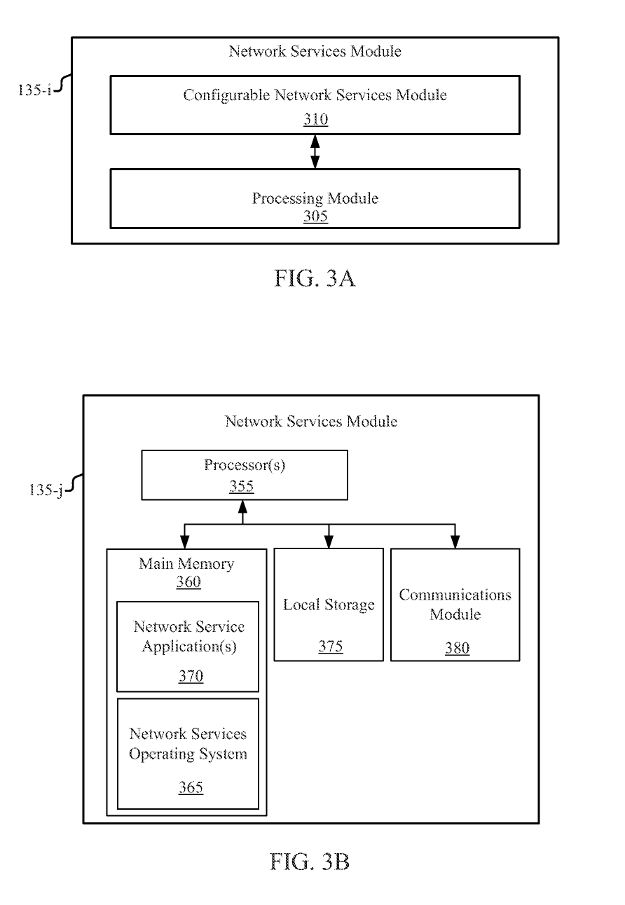

FIG. 3A is a block diagram of one example of a network services module 135-i that may be included in a datacenter (e.g., datacenter 115 of FIG. 1) and dynamically allocated to a self-contained network services system 145 to perform network services for the datacenter. The network services module 135-i may be an example of the network services modules 135 described above with respect to FIG. 1, 2A, or 2B. The network services module 135-i of the present example includes a processing module 305 and one or more network service applications 370. Each of these components may be in communication, directly or indirectly.

The processing module 305 may be configured to execute code to execute the one or more network service applications 370 (e.g., applications 205, 210, 215, 220, 225 of FIG. 2A or 2B) to implement one or more network services selected for the network services module 135-i. In some examples, the processing module 305 may include one or more computer processing cores that implement an instruction set architecture. Examples of suitable instruction set architectures for the processing module 305 include, but are not limited to, the x86 architecture and its variations, the PowerPC architecture and its variations, the Java Virtual Machine architecture and its variations, and the like.

In certain examples, the processing module 305 may include a dedicated hardware processor. Additionally or alternatively, the processing module 305 may include a virtual machine implemented by a physical machine through a hypervisor or an operating system. In still other examples, the processing module 305 may include dedicated access to shared physical resources and/or dedicated processor threads.

The processing module 305 may be configured to interact with the network service applications 370 to implement one or more network services. The network service applications 370 may include elements of software and/or hardware that enable the processing module 305 to perform the functionality associated with at least one selected network service. In certain examples, the processing module 305 may include an x86 processor and one or more memory modules storing the one or more network service applications 370 executed by the processor to implement the at least one selected network service. In these examples, the network services implemented by the network services module 135-i may be dynamically reconfigured by adding code for one or more additional network service applications 370 to the memory modules, removing code for one or more existing network service applications 370 from the memory modules, and/or replacing the code corresponding to one or more network service applications 370 with code corresponding to one or more different network service applications 370.

In additional or alternate examples, the processing module 305 may include an FPGA and the network service applications 370 may include code that can be executed by the FPGA to configure logic gates within the FPGA, where the configuration of the logic gates determines the type of network service(s), if any, implemented by the FPGA. In these examples, the network services implemented by the network services module 135-j may be dynamically reconfigured by substituting the gate configuration code in the FPGA with new code corresponding to a new network services configuration.

FIG. 3B illustrates a more detailed example of a network services module 135-j that may be used in a self-contained network services system (e.g., the self-contained network system 145 of FIG. 1) consistent with the foregoing principles. The network services module 135-j may be an example of a network services module in a network services system. The network services module 135-j of the present example includes a processor 355, a main memory 360, local storage 375, and a communications module 380. Each of these components may be in communication, directly or indirectly.

The processor 355 may include a dedicated hardware processor, a virtual machine executed by a hypervisor, a virtual machine executed within an operating system environment, and/or shared access to one or more hardware processors. In certain examples, the processor 355 may include multiple processing cores. The processor 355 may be configured to execute machine-readable code that includes a series of instructions to perform certain tasks. The machine-readable code may be modularized into different programs. In the present example, these programs include a network services operating system 365 and a set of one or more network service applications 370.

The operating system 365 may coordinate access to and communication between the physical resources of the network services module 135-j, including the processor 355, the main memory 360, the local storage 375, and the communications module 380. For example, the operating system 365 may manage the execution of the one or more network service application(s) 370 by the processor 355. This management may include assigning space in main memory 360 to the application 370, loading the code for the network service applications 370 into the main memory 360, determining when the code for the network service applications 370 is executed by the processor 355, and controlling access by the network service applications 370 to other hardware resources, such as the local storage 375 and communications module 380.

The operating system 365 may further coordinate communications for applications 370 executed by the processor 355. For example, the operating system 365 may implement internal application-layer communications, such as communication between two network service applications 370 executed in the same environment, and external application-layer communications, such as communication between a network service applications 370 executed within the operating system 365 and a network service applications 370 executed in a different environment using network protocols.

As described in more detail below, in certain examples the operating system 365 may be a custom operating system with optimizations and features that allow the processor 355 to perform network processing services at speeds matching or exceeding that of special-purpose hardware appliances designed to provide equivalent network services.

Each network service application 370 executed from main memory 360 by the processor may cause the processor 355 to implement a specific type of network service functionality. As described above, network service applications 370 may exist to implement firewall functionality, load balancing functionality, storage acceleration functionality, security functionality, and/or any other network service that may suit a particular application of the principles of this disclosure.

Thus, the network services module 135-j may dynamically add certain elements of network service functionality by selectively loading one or more new network service applications 370 into the main memory 360 for execution by the processor 355. Similarly, the network services module 135-j may be configured to dynamically remove certain elements of network services functionality by selectively terminating the execution of one or more network service applications 370 in the main memory 360.

The local storage 375 of the network services module 135-j may include one or more real or virtual storage devices specifically associated with the processor 355. In certain examples, the local storage 375 of the network services module may include one or more physical media (e.g., magnetic disks, optical disks, solid-state drives, etc.). In certain examples, the local storage 375 may store the executable code for the network services operating system 365 and network service applications 370 such that when the network services module 135-j is booted up, the code for the network services operating system 365 is loaded from the local storage 375 into the main memory 360 for execution. When a certain type of network service is desired, the network service application(s) 370 corresponding to the desired network service may be loaded from the local storage 375 into the main memory 360 for execution. In certain examples, the local storage 375 may include a repository of available network service applications 370, and the network service functionality implemented by the network services module 135-j may be dynamically altered in real time by selectively loading or removing network service applications 370 into or from the main memory 360.

The communications module 380 of the network services module 135-j may include logic and hardware components for managing network communications with client devices, other network services modules 135, and other network components. In certain examples, the network services module 135-j may receive network data over the communications module 380, process the network data with the network service applications 370 and the network services operating system 365, and return the results of the processed network data to a network destination over the communications module. Additionally, the communications module 380 may receive instructions over the network for dynamically reconfiguring the network services functionality of the network services module 135-j. For example, the communications module 380 may receive an instruction to load a first network service application 370 into the main memory 360 for execution and/or to remove a different network service application 370 from the main memory 360.

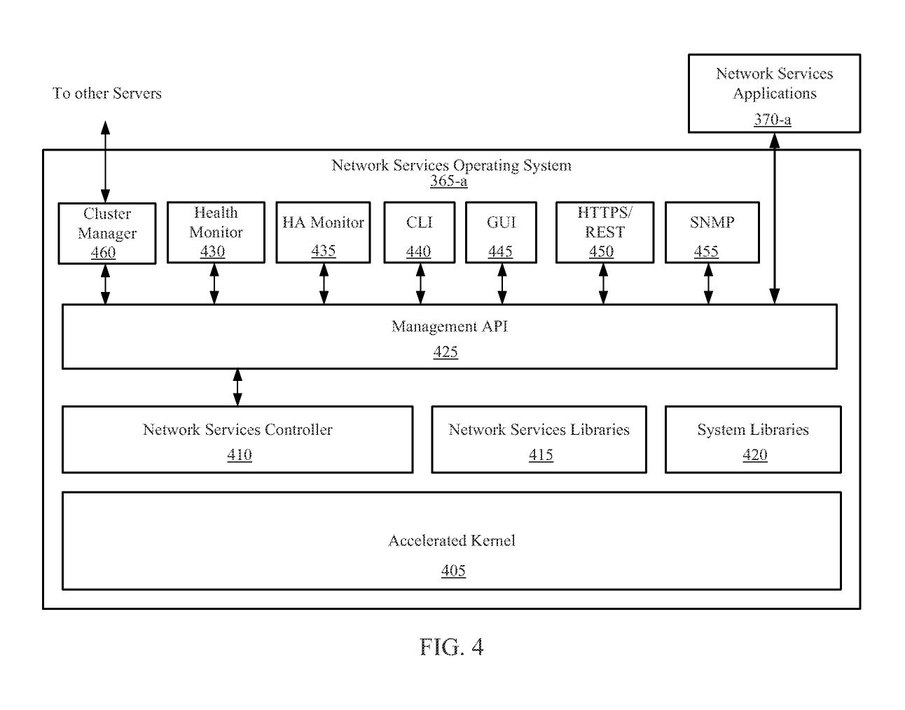

As described above, each network services module 135 in a self-contained network services system 145 may be configured to execute one or more instances of a custom operating system with optimizations and features that allow the processor 355 to perform network processing services at speeds matching or exceeding that of special-purpose hardware appliances designed to provide equivalent network services. FIG. 4 illustrates an example architecture for one such operating system 365-a. The operating system 365-a may be an example of the operating system 365 described above with reference to FIG. 3B. Additionally, the operating system 365-a may be a component of the processing module 305 and/or the configurable network services module 370 described above with reference to FIG. 3A.

The operating system 365-a of the present example includes an accelerated kernel 405, a network services controller 410, network services libraries 415, system libraries 420, a management Application Programming Interface (API) 425, a health monitor 430, a High Availability (HA) monitor 435, a command line interface (CLI) 440, a graphical user interface (GUI) 445, a Hypertext Transfer Protocol Secure (HTTP)/REST interface 450, and a Simple Network Management Protocol (SNMP) interface 455. Each of these components may be in communication, directly or indirectly. The operating system 365-a may be configured to manage the execution of one or more network services applications 370-a. The one or more network services applications 370-a may be an example of the network services applications 370 described above with respect to FIG. 3. As described above, the network services applications 370-a may run within an environment provided by the network services operating system 365-a to implement various network services (e.g., firewall services, load balancing services, storage accelerator services, security services, etc.). Additionally, the operating system 365-a may be in communication with one or more third party management applications 460 and/or a number of other servers and network services modules.

The accelerated kernel 405 may support the inter-process communication and system calls of a traditional Unix, Unix-like (e.g., Linux, OS/X), Windows, or other operating system kernel. However, the accelerated kernel 405 may include additional functionality and implementation differences over traditional operating system kernels. For example, the additional functionality and implementation differences may substantially increase the speed and efficiency of access to the network stack, thereby making the performance of real-time network services possible within the operating system 365-a without imposing delays on network traffic. Examples of such kernel optimizations are given in more detail below.

The accelerated kernel 405 may dynamically manage network stack resources in the accelerated kernel 405 to ensure efficient and fast access to network data during the performance of network services. For example, the accelerated kernel 405 may optimize parallel processing of network flows by performing load balancing operations across network stack resources. In certain embodiments, the accelerated kernel 405 may dynamically increase or decrease the number of application layer threads or driver/network layer threads accessing the network stack to balance work loads and optimize throughput by minimizing blocking conditions.

The network services controller 410 may implement a database that stores configuration data for the accelerated kernel 405 and other modules in the network services operating system 365-a. The network services controller 410 may allow atomic transactions for data updates, and notify listeners of changes. Using this capability, modules (e.g., the health monitor 430, the HA monitor 435) of the network services operating system 365-a may effect configuration changes in the network services operating system 365-a by updating configuration data in the network services controller 410 and allowing the network services controller 410 to notify other modules within the network services operating system 365-a of the updated configuration data.

The management API may communicate with the network services controller 410 and provide access to the network services controller 410 for the health monitor 430, the HA monitor 435, the command line interface 440, the graphical user interface 445, the HTTPS/REST interface 450, and the SNMP interface 455.

The health monitor 430 and the high availability monitor 435 may monitor conditions in the network services operating system 365-a and update the configuration data stored at the network services controller 410 and to tune network stack access and/or other aspects of the accelerated kernel 405 to best adapt to a current state of the operating system 365-a. For example, the health monitor 430 may monitor the overall health of the operating system 365-a, detect problematic conditions that may introduce delay into network stack access, and respond to such conditions by retuning the balance of application layer threads and driver layer threads that access the network stack to achieve a more optimal throughput. The high availability monitor 435 may dynamically update the configuration data of the network services controller 410 to assign one or more servers implemented by the network services operating system 365-a to respond to traffic for a given IP address.

In additional or alternative examples, the management API 425 may also receive instructions to dynamically load or remove one or more network services applications 370-a on the host network services module 135 and/or to make configuration changes to network services operating system 365-a.

The management API 425 may communicate with an administrator or managing process by way of the command line interface 440, the graphical user interface 445, the HTTPS/REST interface 450, or the SNMP interface 455. Additionally, the network services operating system 365-a may support one or more third-party management applications that communicate with the management API 425 to dynamically load, remove, or configure the network applications managed by the network services operating system 365-a. In certain examples, the network services operating system 365-a may also implement a cluster manager 460. The cluster manager 460 may communicate with other network services modules 135 in a self-contained network services module (e.g., the network services system 145 of FIG. 1, 2A, or 2B) to coordinate the distribution of network services among the network services modules 135.

By way of the cluster manager 460, the network services operating system 365-a may receive an assignment of certain network services applications 370-a to execute. Additionally or alternatively, the cluster manager 460 may assign other network services modules 135 in the network services system to execute certain network services applications 370-a based on input received over the command line interface 440, the graphical user interface 445, the HTTPS/REST interface 450, the SNMP interface 455, and/or the third party management application(s). By implementing communication with other network services modules 135 in a cluster, the cluster manager 460 enables dynamic horizontal scalability in the delivery of network services.

The network services operating system 365-a may also implement various software libraries 415, 420 for use by applications executed within the environment provided by the network services operating system. These libraries may include network services libraries 415 and ordinary system libraries 420. The network services libraries 415 may include libraries that are specially developed for use by the network services applications 370-a. For example, the network services libraries 415 may include software routines or data structures that are common to different types of network services applications 370-a.

The system libraries 420 may include various libraries specific to a particular operating system class implemented by the network services operating system 365-a. For example, the network services operating system 365-a may implement a particular Unix-like interface, such as FreeBSD. In this example, the system libraries 420 of the network services operating system 365-a may include the system libraries associated with FreeBSD. In certain examples, the system libraries 420 may include additional modifications or optimizations for use in the provision of network services. By implementing these system libraries 420, the operating system 365-a may be capable of executing various unmodified third-party applications (e.g., third party management application(s) 460). These third-party applications may, but need not, be related to the provision of network services.

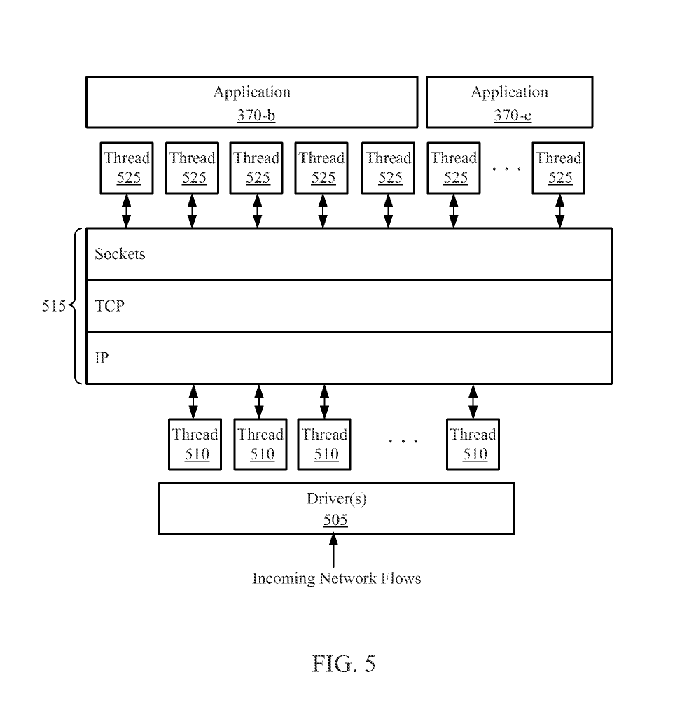

FIG. 5 illustrates a block diagram of one example of network stack management within a network services operating system. For example, the network stack management shown in FIG. 5 may be performed by the accelerated kernel 405 and network services controller 410 of the network systems operating system 365-a of FIG. 3.

In the present example, a network stack 515 includes data related to network communications made at the Internet Protocol (IP) level, data related to network communications made at the Transmission Control Protocol (TCP) level (e.g., TCP state information), and data related to TCP sockets. Incoming network flows that arrive at one or more input threads 510 network ports may be added to the network stack 515 and dynamically mapped to one or more application threads 525. The application threads 525 may be mapped to one or more stages of running applications 370. The mapping of incoming network flows to application threads 525 may be done in a way that balances the work load among the various application threads 525. For example, if one of the application threads 525 becomes overloaded, new incoming network flows may not be mapped to that application thread 525 until the load on that application thread is reduced.

For example, consider the case where the operating system executes network services applications 370 for a web site and a command is received (e.g., at management API 425 of FIG. 4) to enable Hypertext Transfer Protocol Secure (HTTPS) functionality. To do so, the operating system may instruct the network services security application 370 to load a cryptographic library with which to encrypt and decrypt data carried in incoming and outgoing network packets. In light of the CPU-intensive nature of cryptographic operations the number of application threads 525 may be dynamically increased and the number of incoming threads 505 may be correspondingly decreased. By shifting more processing resources to the network services security application, the potential backlog in HTTPS packet processing may be averted or reduced, thus optimizing throughput.

Additionally, the network stack 515 of the present example may be configured to allow for concurrent access by multiple processor threads 510. In previous solutions, each time a thread accesses a network resource (e.g., TCP state information in the network stack 515), other threads are locked out of accessing that collection of network resource (typically the entire set). As the number of network connections increases, contention for the shared network resource may increase resulting in head of line blocking and thereby effectively serializing network connection processes that are intended to occur in parallel. By including the use of a large hash table with fine-grained locking, the probability of contention for shared network resources approaches zero. Further, by dynamically balancing the processing load between application threads 525, the operating system of the present example may evenly distribute the demand for network stack resources across the total number of threads 510, thereby improving data flow

These types of optimizations to the network stack 515 of the present example may be implemented without altering the socket interfaces of the operating system. Thus, where the network operating system is running on a standard general-purpose processor architecture (e.g., the x86 architecture), any network application designed for that architecture may receive the benefits of increased throughput and resource efficiency in this environment without need of altering the network application.

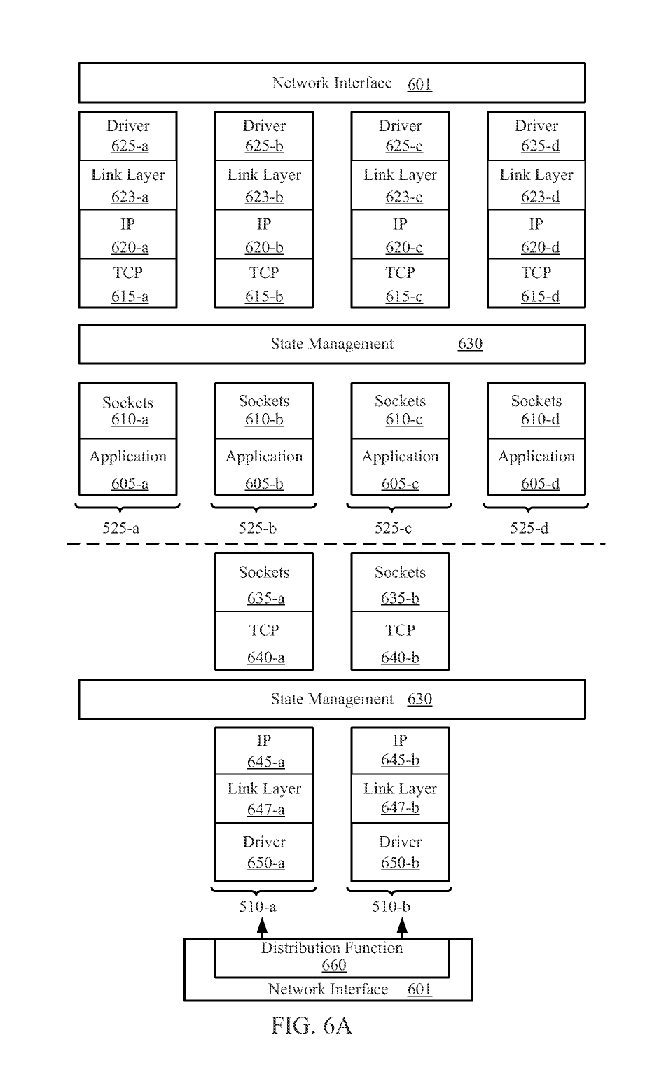

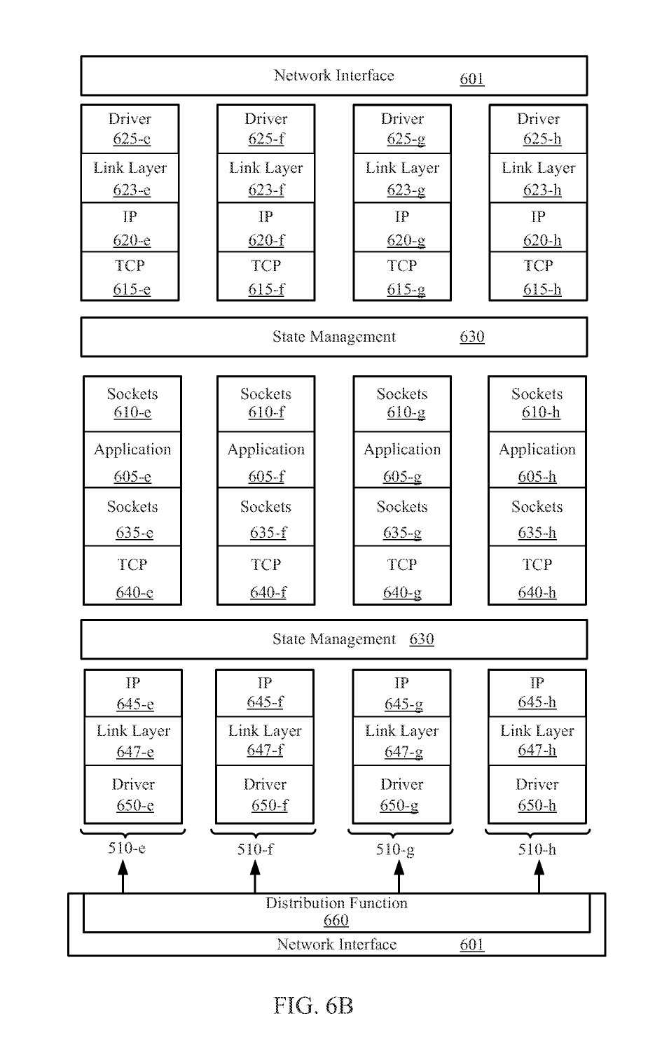

FIG. 6A illustrates another example of balanced load optimizations for processing network packets that may occur in an accelerated kernel of a network services operating system (e.g., the operating system 365 of FIG. 3 or 4). In the present example, a number of application threads 525 are shown. Each application thread 525 may be associated with one or more application stages 605. The application stages may be associated with the network services applications 205, 210, 215, 220, 225, 370 described above with respect to the previous Figures. Each of the application threads 525 may be configured to output network packets by performing outgoing socket processing 610, outgoing TCP level processing 615, outgoing IP level processing 620, outgoing link layer processing 623, and outgoing driver level processing 625. As part of this processing, the application threads 525 may access one or more state management tables 630 in parallel.

As further shown in FIG. 6A, input processing may be decoupled from output processing such that only network threads 510 receive and process packets received from the network. Thus, network threads 510-a and 510-b may be currently configured to perform incoming driver level processing 650, incoming link layer processing 647, incoming IP level processing 645, incoming TCP level processing 640, and incoming socket processing 635. Additionally, network threads 510-a and 510-b may be configured to access one or more state management tables 630 in parallel. In certain examples, the use of a large hash table in connection with fine-grained locking may enable fast concurrent access to the state management tables 630 with minimal lockout issues.

In one example, application threads 525 may all equally process and handle new incoming network flows. By contrast, in another example, application threads 525-a and 525-d may become overloaded (e.g. number of connections to service) with respect to threads 525-b and 525-c. In this situation threads 525-a and 525-d may independently or by instruction by a component of the network service operating system (365-a FIG. 4) to temporarily reduce the rate at which they process and handle new incoming network flows until their load is balanced with respect to threads 525-b and 525-c. This re-configuration of the application threads 525 may dynamically occur, for example, in response to the application stages associated with application threads 525-a and 525-d receiving a stream of high-work packets (e.g., multiple HTTPS terminations). By diverting additional incoming packets to peer applications threads 525-b and 525-c, the overall processing load may be balanced among the application threads 525. However, once the workload associated with application threads 525-a and 525-d is reduced, the system may be dynamically updated such that incoming network flows are again distributed to application threads 525-a and 525-d for processing.

In additional or alternative examples, it may be desirable to increase or decrease the number of application threads 525. Such an increase or decrease may occur dynamically in response to changing demand for network services. For example, an application thread 525 may be added by allocating processing resources to the new application thread 525, associating the new application thread 525 with an appropriate application stage 605, and updating the distribution function 660 such that incoming network flows are distributed to the new application thread 525. Conversely, an application thread 525 may be dynamically removed to free up processing resources for another process by allowing the application thread 525 to finish any pending processing tasks assigned to the application thread, updating the distribution function 660, and reallocating the resources of the application thread 525 somewhere else. This dynamic increase or decrease of application threads 525 may occur without need of rebooting or terminating network services.

As further shown in FIG. 6A, incoming network flows may be assigned to network threads 510 using a distribution function 660. The distribution function 660 may be, for example, a modularized hashing function. The number of network threads 510 that receive and process incoming network flows may be dynamically altered by, for example, changing a modulus of the distribution function 660.

FIG. 6B illustrates another example of balanced load optimizations for processing network packets that may occur in an accelerated kernel of a network services operating system (e.g., the operating system 365 of FIG. 3 or 4). In the present example, a number of network threads 510 are shown. Each network thread 510 may be associated with both its counterpart's tasks in FIG. 6A as well as the tasks associated with an application thread 525 in FIG. 6. The dynamic re-balancing and re-configuration described above may be similarly accomplished in this configuration by having network threads 510 increase and decrease the rate at which they process and handle new incoming flows.

It is worth noting that while an entire system for providing network services using commodity servers has been described as a whole for the sake of context, the present specification is directed to methods, systems, and apparatus that may be used with, but are not tied to the system of FIGS. 1-6. Individual aspects of the present specification may be broken out and used exclusive of other aspects of the foregoing description. This will be described in more detail, below.

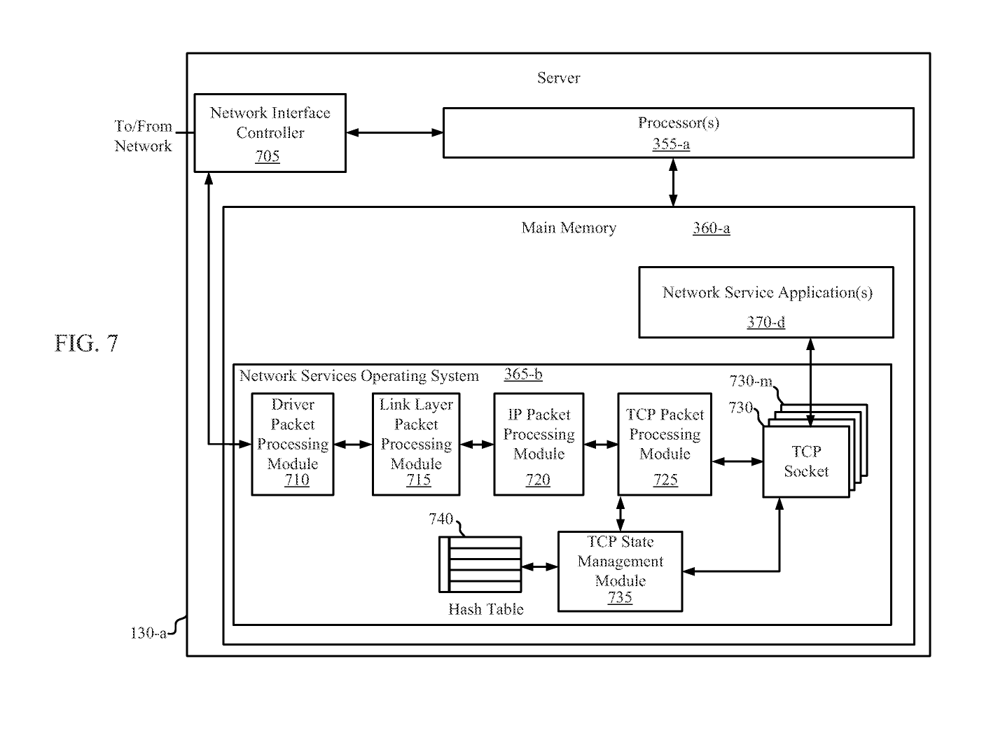

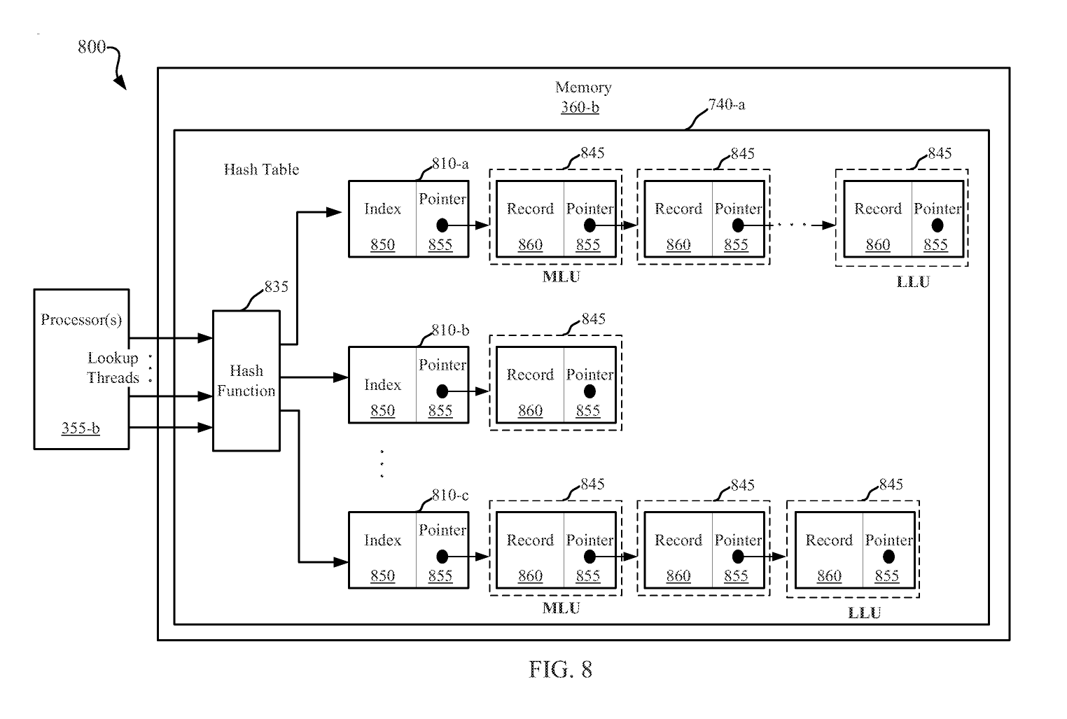

Referring next to FIG. 7, an example of a server 130-a is shown. The server 130-a may be an example of the servers 130 described above with reference to FIGS. 1-3B. As further set forth in the preceding Figures, the server 130 may be used to implement a network services module 135 in a self-contained network services system 145. The server 130-a of the present example includes a processor 355-a, a main memory 360-a, and a network interface controller 705. Each of these components may be in communication, directly or indirectly. The processor 355-a and main memory 360-a may be examples of the processor 355 and main memory 360 described above with reference to FIG. 3. The main memory 360-a may include a network services operating system 365-b and a number of network service applications 370-d.

The network services operating system 365-b may be an example of the network services operating system 365 described above with reference to FIG. 3B or 4. The network services operating system 365 of the present example may implement a driver packet processing module 710, a link layer packet processing module 715, an Internet Protocol (IP) packet processing module 720, a Transmission Control Protocol (TCP) packet processing module 725, a number of TCP sockets 730, a TCP state management module 735, and at least one hash table 740. Incoming packets from the network interface controller 705 may be received and processed by the driver packet processing module 710, and then passed through the link layer packet processing module 715, and the IP packet processing module 720 to produce a TCP packet for the TCP packet processing module 725. Outgoing TCP packets from the TCP packet processing module 725 may be transmitted to the IP packet processing module, which may encapsulate the outgoing TCP packets into one or more outgoing IP packets. The link layer packet processing module 715 may encapsulate the outgoing IP packet(s) into one or more link layer packets, and the driver packet processing module 710 may encapsulate the outgoing link layer packet(s) into one or more driver layer packets for transmission over the network via the network interface controller 705.

FIG. 8 illustrates one example of a network device 800 using a hash table 740-a that is optimized for associating large amounts of data with individual buckets 810. The network device 800 may be an example of one or more of the servers 130, switches 125, routers 120, data stores 140, or other network devices described above with reference to the previous Figures. The network device 800 may include one or more processors 355-b communicatively coupled with a memory 360-b configured to store the hash table 740-a.

The hash table 740-a may be used by the kernel (e.g., the accelerated kernel 405 of FIG. 4) of a network services operating system (e.g., the network services operating system 365 of FIG. 3B, 4, or 7A). Alternatively, the hash table 740-a may be used by one or more of the network services applications 205, 210, 215, 220, 225, 370 described above with reference to FIGS. 2-3. The network services operating system 365 may implement multiple hash tables 740-a for different purposes. For example, hash tables 740-a may be used to perform server socket lookups, connection socket lookups, socket state lookups, load balancing operations, and other operations.

As shown in FIG. 8, the hash table 740-a may include a hash function 835 and a number of buckets 810. Lookup threads may be able to access data in the hash table 740-a by providing a hash key to the hash function 835, which may deterministically identify one of the buckets 810 of the hash table 740-a based on the hash key. The hash function 835 may include any hash function that may suit a particular application of the principles of this disclosure. Once the bucket 810 is identified based on the hash key, the lookup thread may find the identified bucket in memory using an index 850 associated with the identified bucket 810. Each of the buckets 810 may include such an index 850, and the indices 850 may be based on the respective locations of the buckets 810 in memory. The index 850 for each bucket 810 may be a unique identifier assigned to the bucket 810 to distinguish the bucket 810 from other buckets 810 in the hash table 740-a.

In the present example, each of the buckets 810 may include a pointer 855 associated with the index 850 for that bucket 810. The pointer 855 associated with the index 850 may point to a memory location of a container (e.g., linked list, binary tree, other data structure, etc.) of records 860 associated with the bucket 810. In examples, where more than one record is stored in a bucket 810, the pointer 855 associated with the index 850 may point to a record 860 that is associated with a first node 845 in a linked list. The linked list may include a number of nodes 845, where each node contains at least a record 860 and a pointer 855 to a next node 845 in the linked list. The pointer 855 of the last node 845 in the linked list of a bucket may point to a null value to indicate the end of the linked list.

Thus, in the example of FIG. 8, when a lookup thread provides a key that hashes to a bucket 810, the lookup thread may invoke the hash function 835 to identify the index 850 of that bucket 810 and follow the first pointer 855 associated with the index 850 to the first record 860 of that bucket 810. The lookup thread may determine whether the first record 860 matches the hash key and/or other criteria provided by the lookup thread. If the first record 860 does not contain data associated with the hash key and/or the other criteria, the state lookup thread may follow the pointer associated with the first record 860 to the second data element, propagating through the linked list of the identified bucket 810 until a record 860 associated with the hash key is found.

In certain examples, much of the data stored in the hash table 740-a may be stored in a relatively small number of buckets 810. But in certain hash tables, a large amount of information may be disproportionately allocated to buckets associated with popular hash keys. For example, consider a hash table 740-a used to store listening socket information for network connections. The hash key for each connection may be based on a local port number. However, in many networks, a majority of connections may be received at a small number of popular ports (e.g., TCP ports 80, 8080, and 443). Accordingly, the buckets 810 associated with these ports in hash table 740-a used to lookup listening socket information for the connections may include a disproportionately large number of records 860.

It can be computationally expensive to search containers in hash table buckets 810 that contain large numbers of records 860. Thus, large containers associated with hash table buckets 810 may result in delays during lookup operations, and increase the probability of delays.

In light of these considerations, the hash table 740-a of FIG. 8 may improve lookup operations by arranging the linked list nodes 845 associated with each bucket 810 in an order based on an actual or predicted likelihood of use associated with each linked list node 845. The likelihood of use may be measured based on how recently each node 845 has been used, how frequently each node is used, other indicators of node 845 activity, or combinations thereof In this context, a linked list node 845 may be considered used when a lookup thread determines that the record 860 of the linked list node 845 matches selection criteria for the lookup thread and retrieves data from the record 860 as lookup data in response to a query.

As shown in FIG. 8, the linked list nodes 845 for each bucket 810 are ordered from most likely to be used (MLU) to least likely to be used (LLU). That is, the most recently or frequently accessed nodes 845 may be positioned at the beginning of the linked list, and the least recently or least frequently accessed nodes 845 may be positioned at the end of the linked list. Thus, where certain nodes 845 in the linked list are more active than other nodes 845 in the linked list, the more active nodes 845 are available earlier in the linked list. In this way, a more active node 845 of the linked list may be accessed by a lookup thread faster than a less active node 845 of the linked list. Accordingly, average lookup times may improve for the hash table 740-a, and lockout delays may be reduced.

In certain examples, the ordering of the linked list nodes 845 for each bucket 810 may be updated each time a lookup thread accesses the bucket 810 to retrieve data from a node 845. Thus, where likelihood of use is determined or predicted by how recently each node is used, the link list may be updated to position a node 845 at the beginning of the linked list when the node 845 is accessed by a lookup thread. Alternatively, the ordering of the nodes 845 in the linked list for the bucket 810 may be updated periodically, for example, at the expiration of a set time period.

It should be noted that while certain principles of the present disclosure are described in FIG. 8 with respect to the specific example of linked list containers, hash tables employing other types of containers to organize bucket records 860 may also utilize this principle of placing the records 860 most likely to be used or accessed at positions within a bucket container associated with the fastest lookup speeds.

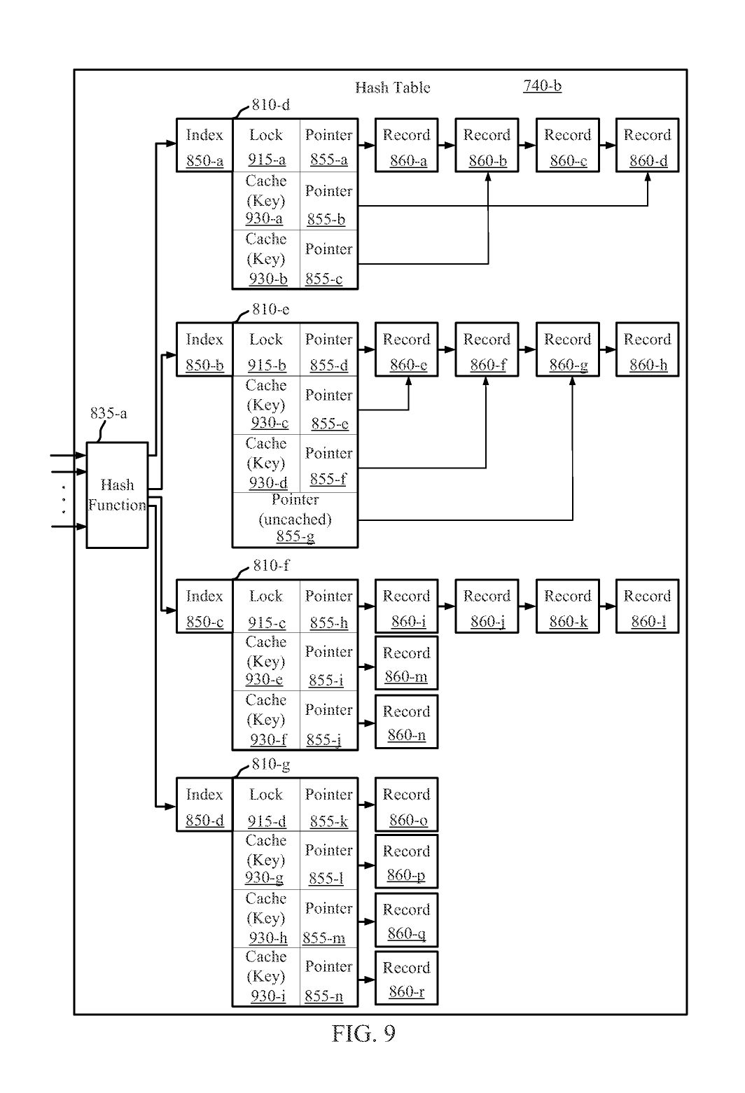

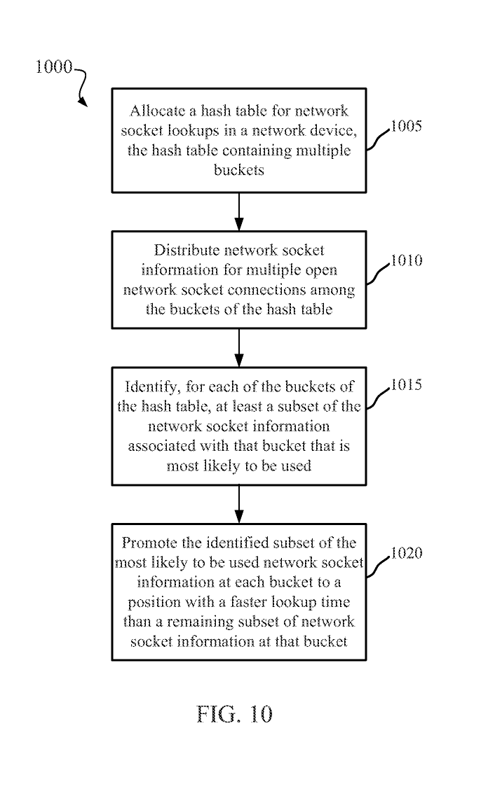

Referring next to FIG. 9, another example is shown of a hash table 740-b that may be used in the kernel (e.g., the accelerated kernel 405 of FIG. 4) of a network services operating system (e.g., the network services operating system 365 of FIG. 3B or 4) and/or by one or more of the network services applications 205, 210, 215, 220, 225, 370 described above with reference to FIGS. 2-3. The hash table 740-b of FIG. 9 may be an example of one or more of the hash tables 740 described above with reference to previous Figures. In certain examples, multiple hash tables 740-b may be implemented for different purposes. For example, the hash table 740-b of the present example may be used to perform server socket/listening socket lookups, connection socket lookups, socket state lookups, and/or for other purposes.

As shown in FIG. 9, the hash table 740-b may include a hash function 835-a and a number of buckets 810, each bucket 810 having an index 850 and a records container associated with a number of records 860. In the present example, the records container may organize the records 860 as a linked list. The linked list may be organized as a group of nodes (e.g., nodes 845 of FIG. 8, not shown in FIG. 9 for clarity) such that each record 860 is associated with a pointer to the next record 860 in the linked list. The last record 860 in each linked list may point to a null value to indicate the end of the linked list. The records 860 of the present example may be examples of the linked list records 860 described above with reference to FIG. 8.

In the hash table 740-b of the present example, each bucket 810 may also include a number of cache entries 830. Each cache entry 830 may be associated with a pointer 855 and store information indicative of one of the records 860 in the linked list of that bucket, and the pointer 855 associated with the cache entry 830 may point to the record 860 for which information is stored. For example, in bucket 810-d, cache entry 830-a may store information indicative of the data in record 860-d, and pointer 855-b may point to record 860-d. Similarly, cache entry 830-b may store information indicative of the data in record 860-b, and pointer 855-c may point to record 860-b.

The cached entries 830 and their associated pointers 855 may increase the speed of some lookup operations in the hash table 740-b. For example, if the hash function 835-a indicates bucket 810-a to a lookup thread based on a hash key, the lookup thread may compare a query from the lookup thread (e.g., the hash key and/or other query data) with information in one or more of the cached entries 830 to determine if an applicable record 860 is identified in the cached entries 830. If one of the cached entries 830 identifies a record 860 applicable to the lookup thread, the lookup thread may follow the pointer 855 associated with that cached entry 830 to the identified record 860 and retrieve the data stored at the identified record 860. On the other hand, if none of the cached entries 830 identifies an applicable record 860, the lookup thread may go to the beginning of the linked list and iterate through each of the records 860 of the linked list until a record 860 applicable to the query of the lookup thread is found.

Iterating through a number of cached entries 830 at each bucket to identify an record 860 applicable to a query of a lookup thread can be computationally less expensive than traversing the linked list to identify the applicable record 860. Consequently, lookup operations performed on records 860 having associated cache entries 830 and pointers 855 in the bucket 810 can be measurably faster than lookup operations performed on other records 860 that are only found by navigating the linked list. Thus, by caching information associated with the most active records 860 in the linked list at a bucket 810, the average lookup time for records 860 associated with that bucket 810 may be reduced.

The buckets 810 shown in FIG. 9 illustrate four different use cases for ordering the records 860 in a linked list associated with a number of cache entries 830. A hash table 735 may implement one or more of these use cases for one, some, or all of its buckets 810.

In the first use case, demonstrated at the first bucket 810-d, the cached records 860 in the linked list may maintain an original order of the linked list irrespective of which records 860 are cached at the bucket. In certain examples, this arrangement may be selected to maintain fast access to the linked list.

In the second use case, demonstrated at the second bucket 810-e, the records 860 in the linked list may be dynamically reordered such that the cached records 860 are at the front of the linked list. An additional pointer 855-g to the uncached portion of the linked list may also be provided at the second bucket 810-e to allow a lookup thread to skip over the cached records 860 when traversing the linked list for an uncached record 860. For example, upon traversing the cached entries 830 without finding a record matching a query, the lookup thread may use the pointer to the uncached portion of the linked list to avoid traversing the cached records 860 in the linked list. In certain examples, the uncached records 860 may be dynamically or periodically ordered according to likelihood of use in the linked list. Alternatively, the uncached records 860 may be unordered.

In the third use case, demonstrated at the third bucket 810-f, the cached records 860 may be removed from the linked list entirely. Records 860 may be dynamically moved between the linked list and the cached entries 830 as threads access the records 860 and the likelihood of use of the different records 860 changes. This example may work well for both linked lists and other containers that do not necessarily have a linear ordering provided. In certain examples, the uncached records 860 may be dynamically or periodically ordered according to likelihood of use in the linked list. Alternatively, the uncached records 860 may be unordered.

In the fourth use case, demonstrated at the fourth bucket 810-g, all of the records 860 associated with the bucket 810-g may be cached, without any of the records 860 organized into a linked list. The cached records 860 may be organized according to likelihood of use, with the cache entries 830 of the records 860 that are most likely to be used in positions with the fastest lookup speed within the cache. Alternatively, the cached records 860 may be unorganized or organized in a different way.

In certain examples, the cache entries 830, pointers 855 associated with the cache entries 830, and/or the ordering of the records 860 in the linked lists may be dynamically updated as records 860 are accessed by lookup threads. Additionally or alternatively, the cache entries 830, the pointers 855 associated with the cache entries 830, and/or the ordering of the records 860 in the linked lists may be updated periodically at the expiration of a predetermined amount of time.

Referring next to FIG. 10, an example of a method 900 of managing hash table lookups is shown. The method 1000 may be performed, for example, by the server 130 of FIGS. 1-3B or 7, the network device 800 of FIG. 8, and/or by the network services operating system 365 of FIG. 3B, 4, or 7.

At block 1005, a hash table may be allocated for network socket lookups in a network device, the hash table containing multiple buckets. At least one of the buckets may be associated with a container configured to store multiple records, such as a linked list, binary tree, or other container. At block 1010, network socket information for multiple open network socket connections may be distributed among the buckets of the hash table. At block 1015, at least a subset of the network socket information stored at each bucket may be identified as most likely to be used. At block 1020, the identified subset of the most likely to be used network socket information may be promoted to a position with a faster lookup time than a remaining subset of network socket information at that bucket.

In certain examples, the network socket information associated with each bucket may be stored in a linked list associated with that bucket. In such examples, the identified subset for at least one of the buckets may be promoted by reordering the linked list of that bucket such that the identified subset of most likely to be used network socket information is stored at an earlier position in the linked list than the remaining subset of network socket information at that bucket.

In certain examples, the identified subset of most likely to be used network socket information may be stored in a cache separate from the linked list or other container associated with that bucket. In such examples, the identified subset of most likely to be used network socket information may be removed from the linked list of that bucket in response to the storage of the identified subset of most likely to be used network socket information in the cache. Alternatively, the identified subset of network socket information may reside in both the cache and the linked list.

In certain examples, the remaining noncached subset of network socket information stored in the linked list or other container of at least one of the buckets based on likelihood of use.

In certain examples, multiple packets may be received at a network device related to multiple different network sockets. Multiple processor threads may concurrently access the network socket information stored in the hash table for each of the different network sockets in parallel. The packet data from the packets may then be passed on to a next layer of packet processing based on the network socket information stored in the hash table.

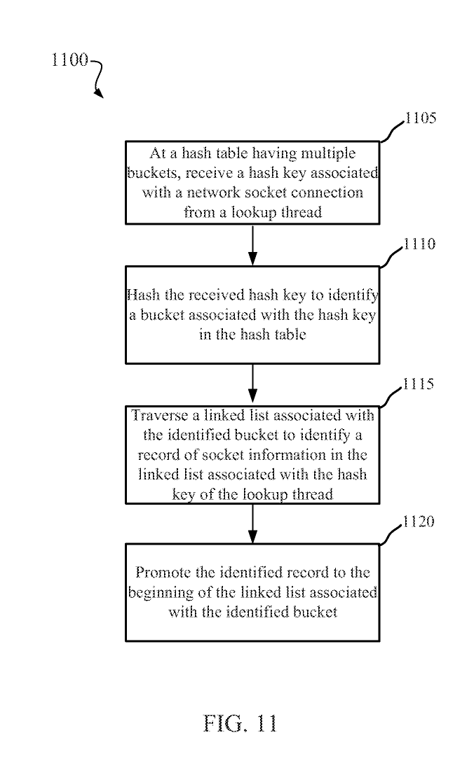

Referring next to FIG. 11, another example of a method 1100 of managing hash table lookups is shown. The method 1100 for example, may be performed, for example, by the server 130 of FIGS. 1-3B or 7, the network device 800 of FIG. 8, and/or by the network services operating system 365 of FIG. 3B, 4, or 7. The method 1100 of FIG. 11 may be an example of the method 1000 of FIG. 10.

At block 1105, a hash key may be received from a lookup thread at a hash table having multiple buckets. At block 1110, the received hash key may be hashed to identify a bucket associated with a network socket connection from a lookup thread. At block 1115, a linked list associated with the identified bucket may be traversed to identify a record of socket information in the linked list associated with the hash key and/or other selection criteria of the lookup thread. At block 1120, the identified record is promoted to the beginning of the linked list associated with the identified bucket.

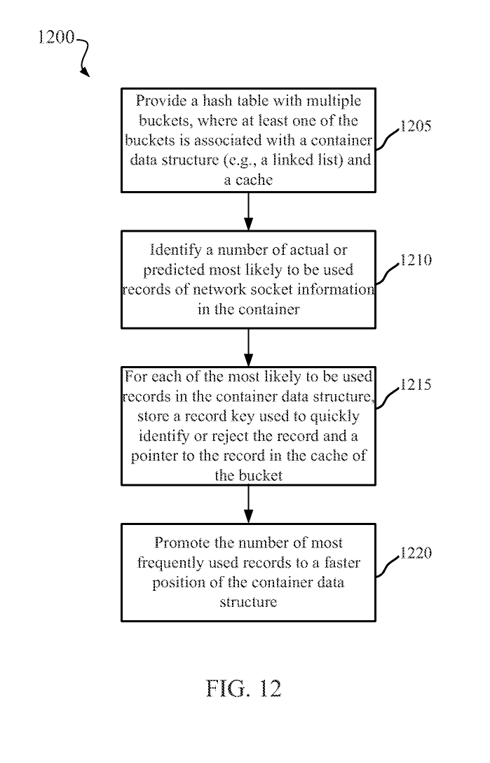

Referring next to FIG. 12, an example of a method 1200 of managing hash table lookups is shown. The method 1200 may be performed, for example, by the server 130 of FIGS. 1-3B or 7, the network device 800 of FIG. 8, and/or by the network services operating system 365 of FIG. 3B, 4, or 7. The method 1200 of FIG. 12 may be an example of one or more of the methods 1000, 1100 described above with reference FIGS. 10-11.

At block 1205, a hash table may be provided. The hash table has multiple buckets, and at least one of the buckets may be associated with a container data structure (e.g., a linked list) and a cache. At block 1210, a number of actual or predicted most likely to be used nodes in the container data structure may be identified. At block 1215, for each of the most likely to be used records in the container data structure, a record key and a pointer to the record may be stored in the cache of the bucket. The record key may be used by a lookup thread to quickly identify or reject the record based. At block 1220, the number of most likely to be used records may be positioned at a slower portion of the container data structure (e.g., at the end of the linked list).

In one example, the cached most likely to be used records may be removed from the container data structure or positioned at the slower portion of the container data structure. In another example, a number of least likely to be used nodes in the linked list may be identified and positioned at the faster portion of container data structure, and information and pointers for the remaining nodes may be stored in the cache. The remaining nodes may also be removed from the container data structure. In still another example, the number of most likely to be used records may be positioned at one portion of the container data structure, and the cache may store a pointer to the remaining portion of the container data structure to provide access to the uncached records.

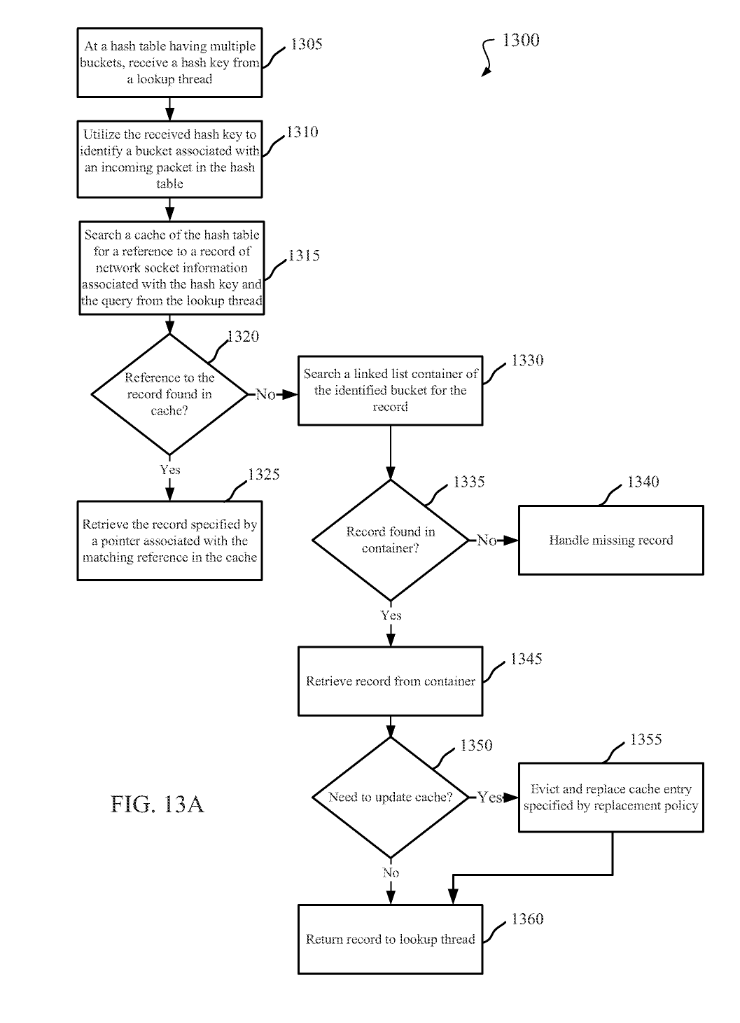

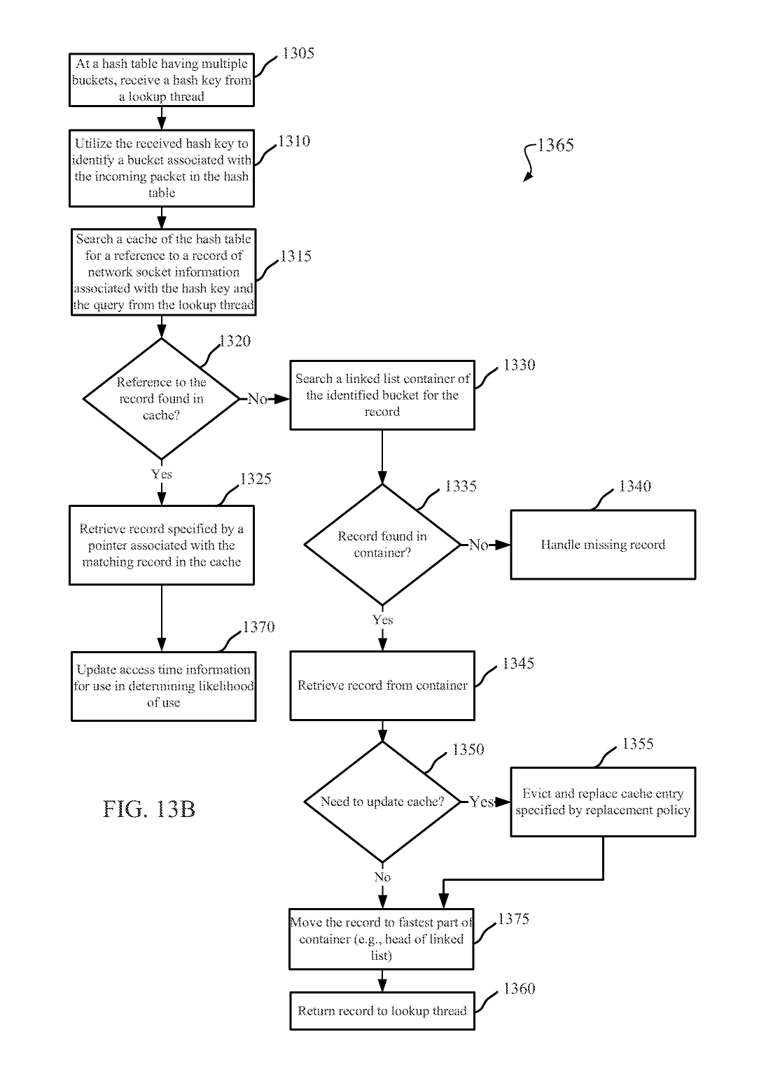

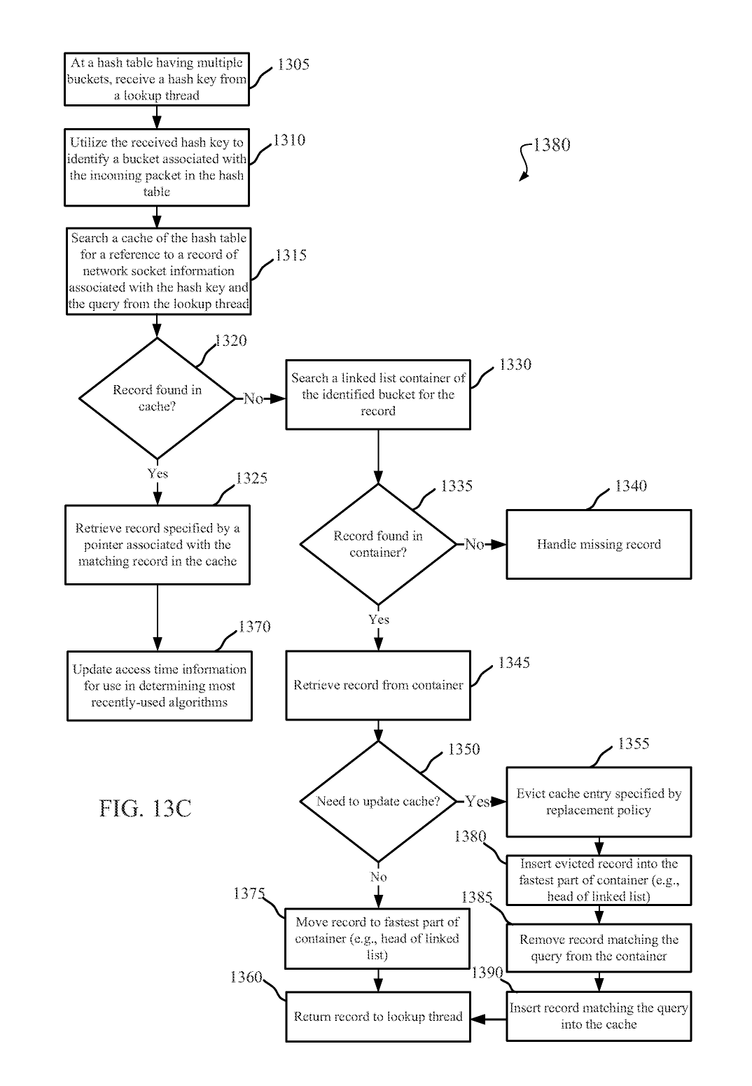

Referring next to FIG. 13A, another example of a method 1300 of managing hash table lookups is shown. The method 1300 may be performed, for example, by the server 130 of FIGS. 1-3B or 7, the network device 800 of FIG. 8, and/or by the network services operating system 365 of FIG. 3B, 4, or 7. The method 1300 of FIG. 13A may be an example of one or more of the methods 1000, 1100, 1200 described above with reference FIGS. 10-12.

At block 1305, a hash key may be received from a lookup thread at a hash table having multiple buckets. At block 1310, the received hash key may be hashed to identify a bucket associated with an incoming packet in the hash table. The bucket may be associated with a record container data structure (e.g., a linked list) and a cache. At block 1315, the cache may be searched for reference to a record of network socket information associated with the hash key and the query from the lookup thread. If the reference to the record is found in the cache (block 1320, YES), the record specified by a pointer associated with the reference to the record in the cache may be retrieved at block 1325. If reference to the record is not found in the cache (block 1320, NO) the linked list container may be searched for a record associated with the query from the lookup thread. If no matching record is found in the container (block 1335, NO), a process for handling a missing record may be invoked at block 1340. If the record is found in the container (block 1335, YES), the record may be retrieved from the container at block 1345. A determination may be made at block 1350 as to whether the cache needs updating. If so (block 1350, YES), one or more cache entries specified by a replacement policy may be evicted and replaced at block 1355. If no updating is needed (block 1350, NO), the record may be returned to the lookup thread at block 1360.

Referring next to FIG. 13B, another example of a method 1365 of managing hash table lookups is shown. The method 1365 may be performed, for example, by the server 130 of FIGS. 1-3B or 7, the network device 800 of FIG. 8, and/or by the network services operating system 365 of FIG. 3B, 4, or 7. The method 1365 of FIG. 13B may be an example of one or more of the methods 900, 1000, 1100, 1300 described above with reference to the previous Figures.

At block 1305, a hash key may be received from a lookup thread at a hash table having multiple buckets. At block 1310, the received hash key may be hashed to identify a bucket associated with an incoming packet in the hash table. The bucket may be associated with a record container data structure (e.g., a linked list) and a cache. At block 1315, the cache may be searched for reference to a record of network socket information associated with the hash key and the query from the lookup thread. If the reference to the record is found in the cache (block 1320, YES), the record specified by a pointer associated with the reference to the record in the cache may be retrieved at block 1325, and access time information may be updated for use in determining the likelihood of use for that record, as described above. If reference to the record is not found in the cache (block 1320, NO) the linked list container may be searched for a record associated with the query from the lookup thread. If no matching record is found in the container (block 1335, NO), a process for handling a missing record may be invoked at block 1340. If the record is found in the container (block 1335, YES), the record may be retrieved from the container at block 1345. A determination may be made at block 1350 as to whether the cache needs updating. If so (block 1350, YES), one or more cache entries specified by a replacement policy may be evicted and replaced at block 1355. If no updating is needed (block 1350, NO), or following enforcement of the replacement policy, the record may be moved to the fastest part of the container (e.g., the head of a linked list) at block 1375, and the record may be returned to the lookup thread at block 1360.

Referring next to FIG. 13C, another example of a method 1380 of managing hash table lookups is shown. The method 1380 may be performed, for example, by the server 130 of FIGS. 1-3B or 7, the network device 800 of FIG. 8, and/or by the network services operating system 365 of FIG. 3B, 4, or 7. The method 1380 of FIG. 13C may be an example of one or more of the methods 1000, 1100, 1200, 1300, 1365 described above with reference to the previous Figures.

At block 1305, a hash key may be received from a lookup thread at a hash table having multiple buckets. At block 1310, the received hash key may be hashed to identify a bucket associated with an incoming packet in the hash table. The bucket may be associated with a record container data structure (e.g., a linked list) and a cache. At block 1315, the cache may be searched for reference to a record of network socket information associated with the hash key and the query from the lookup thread. If the reference to the record is found in the cache (block 1320, YES), the record specified by a pointer associated with the reference to the record in the cache may be retrieved at block 1325, and access time information may be updated for use in determining the likelihood of use for that record, as described above. If reference to the record is not found in the cache (block 1320, NO) the linked list container may be searched for a record associated with the query from the lookup thread. If no matching record is found in the container (block 1335, NO), a process for handling a missing record may be invoked at block 1340. If the record is found in the container (block 1335, YES), the record may be retrieved from the container at block 1345.

A determination may be made at block 1350 as to whether the cache needs updating. If so (block 1350, YES), one or more cache entries specified by a replacement policy may be evicted at block 1355, the evicted record may be inserted into the fastest part of the container (e.g., the head of a linked list) at block 1380, and the record matching the query may be removed from the container at block 1385. The record matching the query may then be inserted into the cache at block 1390, and the record may be returned to the lookup thread at block 1360. If no updating is needed (block 1350, NO), the record may be moved to the fastest part of the container (e.g., the head of a linked list) at block 1375, and the record is returned to the lookup thread at block 1360.

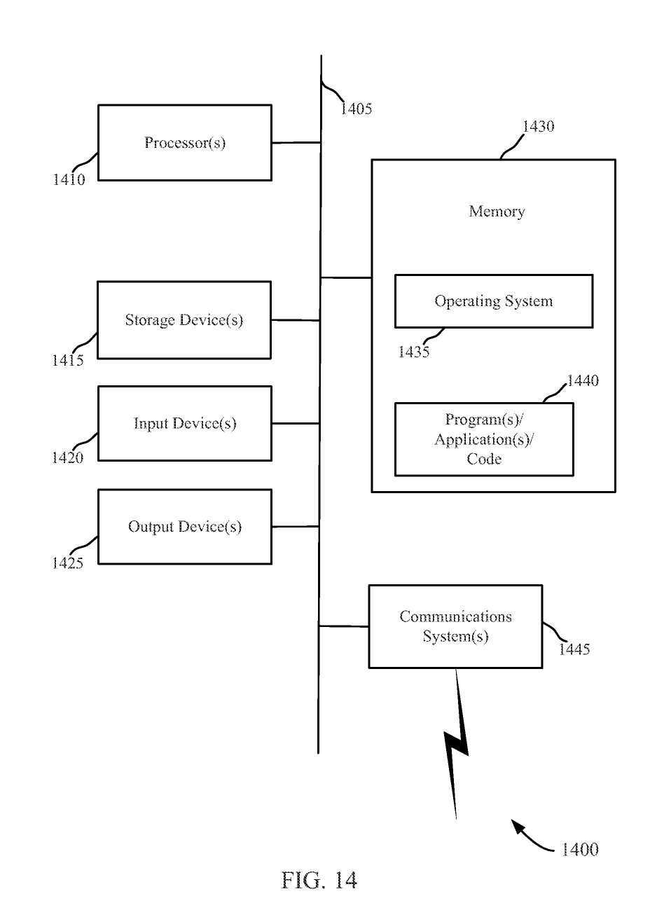

A device structure 1400 that may be used for one or more components of server 130 of FIG. 1-3B or 7, network device 800, or for other computing devices described herein, is illustrated with the schematic diagram of FIG. 14.

This drawing broadly illustrates how individual system elements of each of the aforementioned devices may be implemented, whether in a separated or more integrated manner. Thus, any or all of the various components of one of the aforementioned devices may be combined in a single unit or separately maintained and can further be distributed in multiple groupings or physical units or across multiple locations. The example structure shown is made up of hardware elements that are electrically coupled via bus 1405, including processor(s) 1410 (which may further comprise a digital signal processor (DSP) or special-purpose processor), storage device(s) 1415, input device(s) 1420, and output device(s) 1425. The storage device(s) 1415 may be a machine-readable storage media reader connected to any machine-readable storage medium, the combination comprehensively representing remote, local, fixed, or removable storage devices or storage media for temporarily or more permanently containing computer-readable information.

The communications system(s) interface 1445 may interface to a wired, wireless, or other type of interfacing connection that permits data to be exchanged with other devices. The communications system(s) interface 1445 may permit data to be exchanged with a network. In certain examples, the communications system(s) interface 1445 may include a switch application-specific integrated circuit (ASIC) for a network switch or router. In additional or alternative examples, the communication systems interface 1445 may include network interface cards and other circuitry or physical media configured to interface with a network.

The structure 1400 may also include additional software elements, shown as being currently located within working memory 1430, including an operating system 1435 and other code 1440, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of managing network socket lookups, comprising:
allocating a hash table for network socket lookups in a network device, the hash table comprising a plurality of buckets;
distributing network socket information for a plurality of open network socket connections among the buckets of the hash table;
identifying, for each of the buckets of the hash table, at least a subset of the network socket information associated with that bucket that is most likely to be used; and
promoting the identified subset of most likely to be used network socket information at each bucket to a position comprising a faster lookup time than a remaining subset of network socket information associated with that bucket.

2. The method of claim 1, further comprising:
storing at least a portion of the network socket information associated with each bucket in a linked list associated with that bucket.

3. The method of claim 2, wherein the promoting the identified subset for at least one of the buckets comprises:
reordering the linked list such that the identified subset of most likely to be used network socket information is stored at an earlier position in the linked list than the remaining subset of network socket information associated with the at least one of the buckets.

4. The method of claim 2, wherein the promoting the identified subset for at least one of the buckets comprises:
storing the identified subset of most likely to be used network socket information in a cache separate from the linked list associated with that bucket.

5. The method of claim 4, further comprising:
removing the identified subset of most likely to be used network socket information from the linked list of the at least one of the buckets in response to storing the identified subset of most likely to be used network socket information in the cache.

6. The method of claim 2, further comprising:
reordering the subset of remaining network socket information in the linked list of at least one of the buckets based on a likelihood of use of the remaining network socket information.

7. The method of claim 1, wherein the identified subset of the network socket information that is most likely to be used comprises the network socket information that is most frequently used.

8. The method of claim 1, wherein the identified subset of the network socket information that is most likely to be used comprises the network socket information that has been most recently used.

9. The method of claim 1, further comprising:
receiving a plurality of packets related to a plurality of different network sockets; and
concurrently accessing the network socket information stored in the hash table for each of the different network sockets in parallel using the multiple processor threads.

10. The method of claim 9, further comprising:
passing packet data from the plurality of packets on to a next layer of packet processing based on the network socket information stored in the hash table.

11. A network device for managing network socket information, comprising:
a memory configured to store a hash table allocated to network socket lookups, the hash table comprising a plurality of buckets; and
at least one processor communicatively coupled with the memory, the processor configured to:
distribute network socket information for a plurality of open network socket connections among the buckets of the hash table;
identify, for each of the buckets of the hash table, at least a subset of the network socket information associated with that bucket that is most likely to be used; and
promote the identified subset of most likely to be used network socket information at each bucket to a position comprising a faster lookup time than a remaining subset of network socket information associated with that bucket.

12. The network device of claim 11, wherein the at least one processor is further configured to:
store at least a portion of the network socket information associated with each bucket in a linked list associated with that bucket.

13. The network device of claim 12, wherein the at least one processor is configured to promote the identified subset for at least one of the buckets by:
reordering the linked list such that the identified subset of most likely to be used network socket information is stored at an earlier position in the linked list than the remaining subset of network socket information associated with the at least one of the buckets.

14. The network device of claim 12, wherein the at least one processor is configured to promote the identified subset for at least one of the buckets by:
storing the identified subset of most likely to be used network socket information in a cache separate from the linked list associated with that bucket.

15. The network device of claim 14, wherein the at least one processor is configured to:
remove the identified subset of most likely to be used network socket information from the linked list of the at least one of the buckets in response to storing the identified subset of most likely to be used network socket information in the cache.

16. The network device of claim 12, wherein the at least one processor is configured to:
reorder the subset of remaining network socket information in the linked list of at least one of the buckets based on a likelihood of use of the remaining network socket information.

17. The network device of claim 11, wherein the identified subset of the network socket information that is most likely to be used comprises the network socket information that is most frequently used.

18. The network device of claim 11, wherein the identified subset of the network socket information that is most likely to be used comprises the network socket information that has been most recently used.

19. The network device of claim 11, wherein the at least one processor is configured to:
receive a plurality of packets related to a plurality of different network sockets;
concurrently access the network socket information stored in the hash table for each of the different network sockets in parallel using the multiple processor threads; and
pass packet data from the plurality of packets on to a next layer of packet processing based on the network socket information stored in the hash table.

20. A computer program product for managing network socket information, comprising:
a tangible computer readable storage device comprising a plurality of computer readable instructions stored thereon, the computer-readable instructions comprising:
computer-readable instructions configured to cause at least one processor to allocate a hash table for network socket lookups in a network device, the hash table comprising a plurality of buckets;
computer-readable instructions configured to cause at least one processor to distribute network socket information for a plurality of open network socket connections among the buckets of the hash table;
computer-readable instructions configured to cause at least one processor to identify, for each of the buckets of the hash table, at least a subset of the network socket information associated with that bucket that is most likely to be used; and
computer-readable instructions configured to cause at least one processor to promote the identified subset of most likely to be used network socket information at each bucket to a position comprising a faster lookup time at that bucket than a remaining subset of network socket information associated with that bucket.
